(19) United States
(12) Patent Application Publication
(10) Pub. No.: US 2020/0359001 A1
(43) Pub. Date: Nov. 12, 2020

(54) CAMERA MODULE

(71) Applicant: TRIPLE WIN TECHNOLOGY(SHENZHEN) CO.LTD., Shenzhen (CN)

(72) Inventors: YI-MOU HUANG, New Taipei (TW); YE-QUANG CHEN, Tu-Cheng (TW); SHIN-WEN CHEN, Tu-Cheng (TW); YU-JUNG CHEN, New Taipei (TW); HO-KAI LIANG, New Taipei (TW)

(21) Appl. No.: 16/426,149

(22) Filed: May 30, 2019

(30) Foreign Application Priority Data
May 6, 2019 (CN) 201910372120.7

(51) Int. Cl. H04N 13/239; G03B 35/10

(52) U.S. Cl. CPC H04N 13/239; G03B 2205/0069; H04N 2213/001; G03B 35/10

(57) ABSTRACT

A camera module includes a circuit board, two photosensitive chips fixed on a surface of the circuit board, two lens assemblies respectively mounted over the two photosensitive chips, two filter assemblies each including a visible light filter and an infrared filter, and an infrared projection unit fixed on a surface of the circuit board and projecting patterned infrared light. The filter assemblies respectively correspond to the photosensitive chips and the lens assemblies. The visible light filter and the infrared filter of the filter assemblies are switched to be between the lens assembly and the photosensitive chip. When the visible light filters are between the lenses and the photosensitive chips, the photosensitive chips acquire visible light to form a colored 3D image. When the infrared filters are between the lenses and the photosensitive chips, the photosensitive chips acquire reflected patterned infrared light to form an infrared 3D image.

### FIELD

The subject matter herein generally relates to camera modules, and more particularly to a 3D camera module.

### BACKGROUND

At present, there are two main types of 3D cameras. One type uses an active imaging method, and another type uses a passive imaging method. The 3D camera generally has separate lenses to implement the active imaging method and the passive imaging method for taking 3D pictures. However, the lenses occupy space of the 3D camera, and the lenses have a high cost.

### BRIEF DESCRIPTION OF THE DRAWINGS

Implementations of the present disclosure will now be described, by way of embodiments, with reference to the attached figures.

FIG. 1 is a cross-sectional view of an embodiment of a camera module.

FIG. 2 is similar to FIG. 1, but showing the camera module in another state of use.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

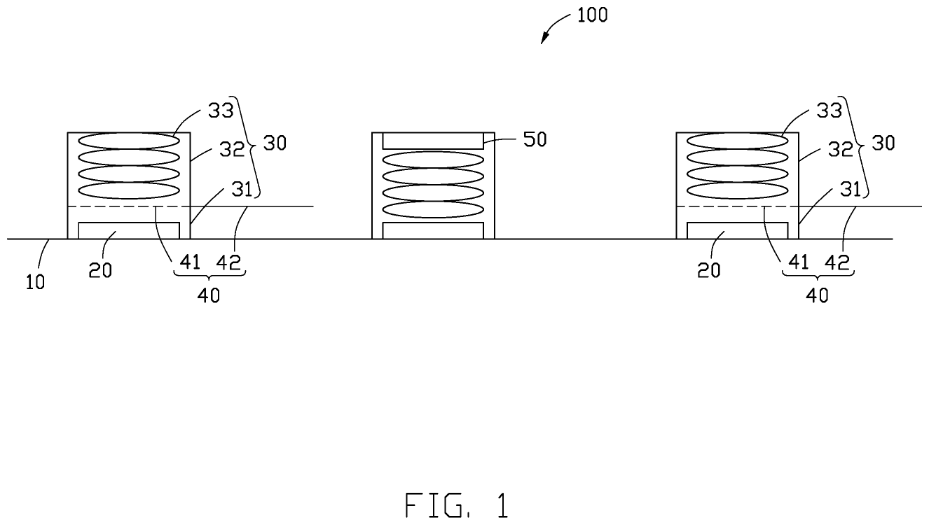

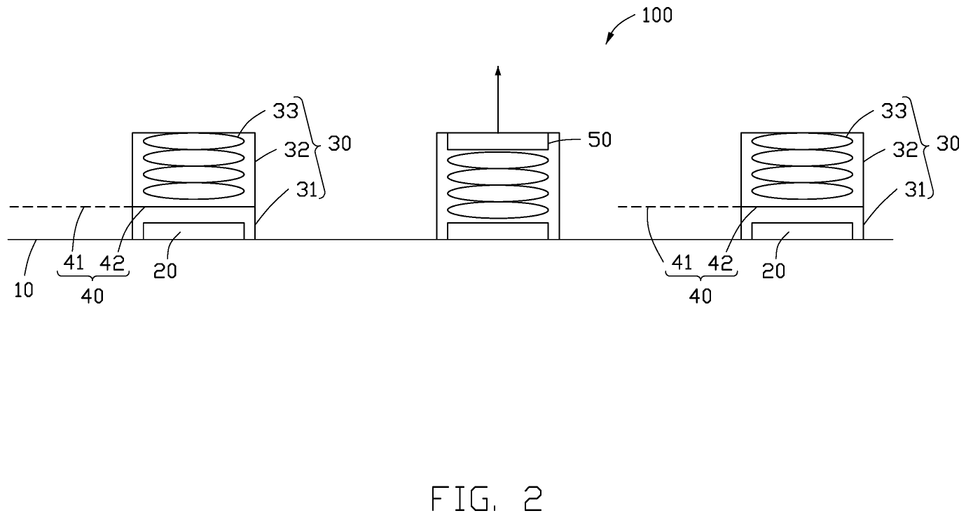

FIGS. 1-2 show an embodiment of a camera module 100. The camera module 100 includes a circuit board 10, two photosensitive chips 20, two lens assemblies 30, two filter assemblies 40, and an infrared projection unit 50.

The two photosensitive chips 20 are each fixed to one surface of the circuit board 10 by an adhesive layer (not shown). In one embodiment, the photosensitive chip 20 is an RGBIR optical sensor that can acquire visible red, green, and blue (RGB) and infrared (IR) light.

In one embodiment, the circuit board 10 may be a ceramic substrate, a soft board, a hard board, or a soft-hard composite board. When the circuit board 10 is a soft-hard composite board, the two photosensitive chips 20 are fixed on one surface of a hard board portion of the circuit board 10.

The lens assembly 30 includes a mounting bracket 31, a lens holder 32, and a lens 33. The mounting bracket 31 and the lens holder 32 are substantially hollow.

The mounting bracket 31 is fixed to the circuit board 10 by an adhesive (not shown). Two receiving holes (not shown) are respectively defined in the two mounting brackets 31 to respectively receive the corresponding photosensitive chips 20.

The lens holder 32 is fixed to a surface of the mounting bracket 31 facing away from the circuit board 10 by an adhesive (not shown). A through hole (not shown) is defined in the lens holder 32 and aligned with the receiving hole. The lens holder 32 can be a voice coil motor or a bracket.

The lens 33 is mounted in the through hole of the lens holder 32. The lens 33 faces the photosensitive chip 20. The lens 33 includes a plurality of lenses. In one embodiment, the lens 33 includes four lenses sequentially disposed, but is not limited thereto. In one embodiment, the lens 33 is made of resin.

The filter assembly 40 includes a visible light filter 41 for filtering RGB light, an infrared filter 42 for filtering IR light, and a switch (not shown). The visible light filter 41 and the infrared filter 42 are movably disposed on the lens assembly 30. The visible light filter 41 and the infrared filter 42 are switched by the switch to be located between the photosensitive chip 20 and the lens 33.

The visible light filter 41 may be a Bayer filter composed of red, blue, and green filters to cause the photosensitive chip 20 acquire a color image. The infrared filter 42 causes the photosensitive chip 20 to acquire an infrared image.

In one embodiment, the visible light filter 41 and the infrared filter 42 are arranged side-by-side on an elongated sheet (not shown). The switch may be a linear motor for driving the elongated sheet to move linearly to switch the visible light filter 41 and the infrared filter 42 to be between the mounting bracket 31 and the lens holder 32, thereby switching the visible light filter 41 and the infrared filter 42 to be between the photosensitive chip 20 and the lens 33. In other embodiments, the visible light filter 41 and the infrared filter 42 may be respectively disposed on two sheets, and there may be two switches to respectively drive the visible light filter 41 and the infrared filter 42. The visible light filter 41 and the infrared filter 42 may also be respectively disposed on a circular sheet, and the switch may drive the circular sheet to rotate about an axis of the sheet.

The infrared projection unit 50 is disposed on the circuit board 10 and located between the two photosensors 20. The infrared projection unit 50 projects patterned infrared light onto an object to be photographed. The infrared projection unit 50 may include an infrared laser emitter (not shown) having diffractive optical elements (not shown) and a projection lens (not shown).

As shown in FIG. 1, when the two switches drive the corresponding visible light filters 41 to be between the photosensitive chip 20 and the lens 33, the infrared projection unit 50 does not project patterned infrared light, and the two photosensitive chips 20 acquire visible light to form a color 3D image. Thus, the camera module 100 works as a visible light passive dual camera module.

As shown in FIG. 2, when the two switches drive the corresponding infrared filters 42 to be between the photosensitive chip 20 and the lens 33, the infrared projection unit 50 projects the patterned infrared light, and the two photosensitive chips 20 acquire reflected patterned infrared light to form an infrared light image and generate an infrared 3D image by calculating deformation of the patterned infrared light. Thus, the camera module 100 works as an infrared active dual camera module.

The camera module 100 uses the visible light filters 41 and the infrared filters 42 to acquire two types of 3D images: color 3D images and infrared 3D images. The camera module 100 has a simple structure and low cost.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A camera module comprising:
a circuit board;
two photosensitive chips fixed on a surface of the circuit board;
two lens assemblies respectively mounted over the two photosensitive chips;
two filter assemblies each comprising a visible light filter and an infrared filter; and
an infrared projection unit fixed on a surface of the circuit board and projecting patterned infrared light; wherein:
the two filter assemblies respectively correspond to the two photosensitive chips and the two lens assemblies;
the visible light filter and the infrared filter of the two filter assemblies are switched to be between the lens assembly and the photosensitive chip;
when the two visible light filters are between the lenses and the photosensitive chips, the photosensitive chips acquire visible light to form a colored 3D image;
when the two infrared filters are between the lenses and the photosensitive chips, the photosensitive chips acquire reflected patterned infrared light to form an infrared 3D image.

2. The camera module of claim 1, wherein:
the photosensitive chip is an RGBIR optical sensor for sensing visible and infrared light.

3. The camera module of claim 1, wherein:
the visible light filter is a Bayer filter composed of red, blue, and green filters.

4. The camera module of claim 1, wherein:
the infrared projection unit is an infrared laser emitter comprising diffractive optical elements and a projection lens.

5. The camera module of claim 1, wherein:
the infrared projection unit is located on the circuit board between the two photosensitive chips.

6. The camera module of claim 1, wherein:
the lens assembly comprises a mounting bracket, a lens holder, and a lens;
the lens bracket is fixed on the surface of the circuit board;
the lens bracket defines a receiving hole for receiving the photosensitive chip;
the lens holder is mounted on the lens bracket and defines a through hole aligned with the lens bracket for receiving the lens;
the lens faces the photosensitive chip.

7. The camera module of claim 6, wherein:
the lens holder is a voice coil motor or a bracket.

8. The camera module of claim 6, wherein:
the visible light filter and the infrared filter are arranged side-by-side and fixedly coupled together;
the filter assembly is driven to switch the visible light filter and the infrared filter to be between the lens and the photosensitive chip.

9. The camera module of claim 6, wherein:
the visible light filter and the infrared filter are arranged side-by-side and not coupled together;
the visible light filter and the infrared filter are separately driven to switch the visible light filter and the infrared filter to be between the lens and the photosensitive chip.

10. The camera module of claim 6, wherein:
the filter assembly is driven by a switch of the filter assembly to switch the visible light filter and the infrared filter.

11. The camera module of claim 10, wherein:
the visible light filter and the infrared filter are arranged side-by-side and fixedly coupled together;
the filter assembly is linearly driven by a single switch to switch the visible light filter and the infrared filter to be between the lens and the photosensitive chip.

12. The camera module of claim 10, wherein:
the visible light filter and the infrared filter are arranged side-by-side and fixedly coupled together;
the filter assembly is driven by a single switch to rotate about an axis to switch the visible light filter and the infrared filter to be between the lens and the photosensitive chip.

13. The camera module of claim 1, wherein:
when the visible light filter is between the lens and the photosensitive chip, the infrared projection unit does not project patterned infrared light;
when the infrared filter is between the lens and the photosensitive chip, the infrared projection unit projects patterned infrared light.

14. A camera module comprising:
a circuit board;
two photosensitive chips fixed on a surface of the circuit board;
two lens assemblies respectively mounted over the two photosensitive chips;
two filter assemblies each comprising a visible light filter and an infrared filter which are switched above the photosensitive chip and
an infrared projection unit fixed on a surface of the circuit board and projecting patterned infrared light; wherein:
when the two visible light filters are above the photosensitive chips, the photosensitive chips acquire visible light to form a colored 3D image;
when the two infrared filters are above the photosensitive chips, the photosensitive chips acquire reflected patterned infrared light to form an infrared 3D image.

15. The camera module of claim 14, wherein:
the photosensitive chip is an RGBIR optical sensor for sensing visible and infrared light.

16. The camera module of claim 14, wherein:
the infrared projection unit is located on the circuit board between the two photosensitive chips.

17. The camera module of claim 14, wherein:
when the visible light filter is between the lens and the photosensitive chip, the infrared projection unit does not project patterned infrared light;
when the infrared filter is between the lens and the photosensitive chip, the infrared projection unit projects patterned infrared light.
